(19) United States
(12) Patent Application Publication
(10) Pub. No.: US 2004/0173058 A1
(43) Pub. Date: Sep. 9, 2004

(54) NutCracker

(75) Inventor: Richard-Andre-Josepholier Desjardins, Ste-Julie (CA)

Correspondence Address: Richard Desjardins, 2060 Rene Levesque, Ste-Julie, QC, J3E-2E6, CA

(73) Assignee: Schurr R&D Corporation, Ste-Julie-de-Vercheres (CA)

(21) Appl. No.: 10/376,474

(22) Filed: Mar. 3, 2003

(51) Int. Cl. B25B 13/06

(52) U.S. Cl. 81/121.1

(57) ABSTRACT

In a tool for releasing a motor vehicles hex lugnuts(1,2,3), it is known that there are four to six hex lugnuts that hold down the rim of a wheel to the studs of any motor vehicle axle. In this invention a 20 inch bar (3)with an adaptor ⅜″ box (1,6) at one end and a “T” bar (2)with support wheels (4) at the other end form a one piece unit to release hex lugnuts on motor vehicles.

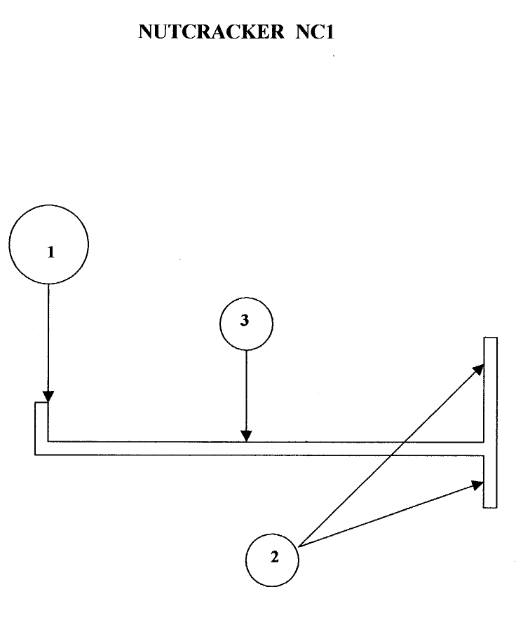

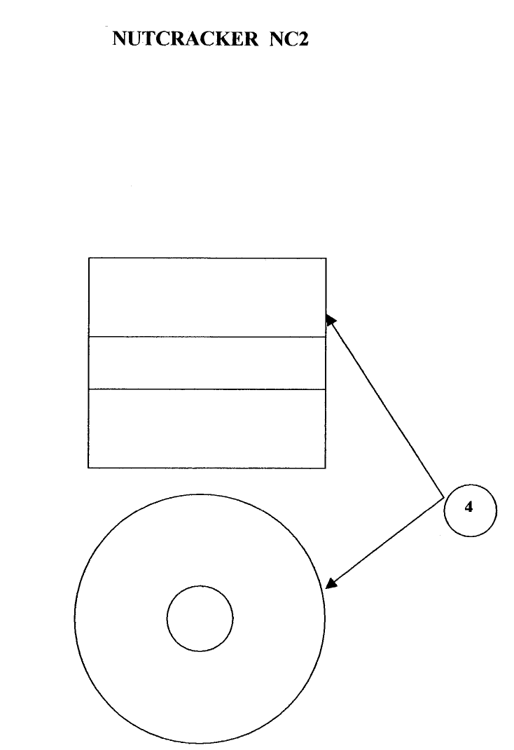

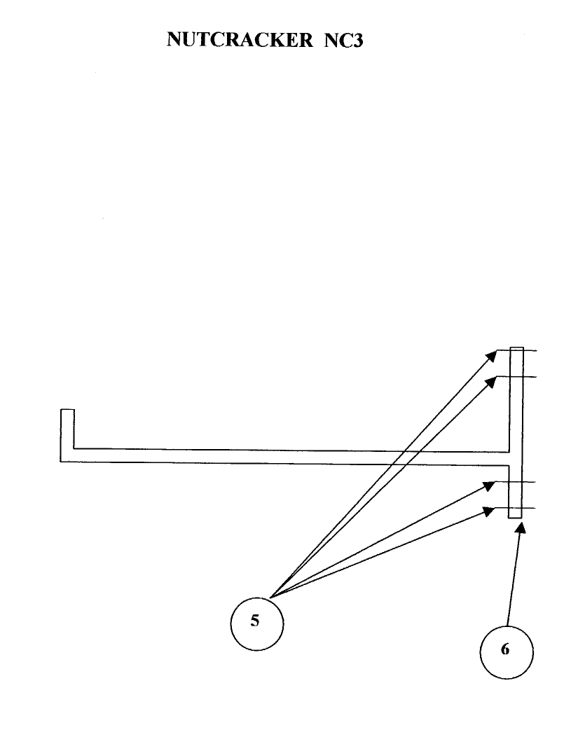

This invention will avoid any future physical injuries involved with removing lugnuts from a wheel whether the gender be male or female. This unit is easily installed and portable. This tool is easier to use because all motor vehicle lugnut removers are short and at times angled outboard of the vehicle making slipping off the lugnut and removing any corroded or jammed by corrosion lugnut almost impossible. Finally as described above the NutCracker effortlessly releases lugnuts without any physical effort to the owner driver of the motor vehicle.

### FIELD OF INVENTION

The present invention relates to motor vehicle wheel lugnuts and more specifically the wheel lugs that hold down the wheel of any motor vehicle to it's axle.

### BACKGROUND OF THE INVENTION

Most automobiles today are presently permitted or mobile in direction by the installation of four circular wheels. The two forward wheels having pivotal capabilities and the two rear wheels having fixed wheel configuration. The four wheels are installed at the manufacturer of their respective builders, by using from four to six or more hex nuts to hold the wheel down onto the wheel axles whether this be the front or rear wheels.

All vehicles are equipped with either crossbars or single receiving hex nut bars to release the nuts from the axle studs when an individual must remove the wheel after encountering a deflation or flat of the tire.

Once the individual encounters a deflated tire or flat it is inevitable that in some cases the individual will have to remove the hex lugnuts from the axle stud holding the tire rim.

Since in most cases the hex lugnuts are installed by garage mechanics using an impact tool the most common problem being the hex lugnuts are on to tight or corrosion has attacked the stud and hex lugnuts and bonded them together making removal of such hex lugnuts difficult if not impossible to remove by human strength alone without suffering back injuries and leaving the female driver also incapable of removing the hex lugnuts without assistance of a commercial organization or passerby.

Since some of the factors mentioned above such as corrosion or impact tool usage will temporarily not permit the individual motor vehicle owner to remove a deflated or flat tire from his or her vehicle without suffering back injuries a hex lugnut release tool is brought in to release or crack loose any jammed hex lugnuts from the wheel axle studs.

In the standard method of removing hex lugnuts the individual male or female will have to use the sometimes very short release bar in the trunk of the vehicle to release the hex lugnuts on the wheel. The majority of these crossbars or single release bars are short, have no grip and no real leverage to release the hex lugnuts with ease.

### SUMMARY AND OBJECTS OF THE INVENTION

It is any object of the present invention to provide a means by which this tool being lightweight may be carried to the wheel hex lugnuts and provide the individual, female or male with the ability to release all hex lugnuts screwed onto the axle studs with absolutely no physical effort on their part and thereby avoiding all physical injuries.

The present invention achieves these objectives by providing a tool which is simply inserted onto the hex lugnut. The tool also has an extended torque shaft which at one end has the hex socket to insert on the hex lugnut and at the other end a “T” shaped bar which retains two roller shaped bearing wheels which when the vehicle is put into reverse with the tool inserted on the left hand side wheels with the roller bearing type wheels sitting right behind the wheel, will release the hex lugnuts one at a time when the vehicle is moved in the reverse mode approximately three inches.

If using the tool on the right hand side of the vehicle then the roller bearing type wheels should be sitting in front of the wheel and the vehicle advanced approximately three inches to release the hex type lugnut.

The roller bearing type wheels need not touch immediately the ground when the hex end socket is inserted onto the hex lugnut. When moving the vehicle in the release direction the wheels on the tool will contact the ground automatically and proceed to roll in the same direction as the vehicle and maintaining the same distance between the tire and the tool wheels throughout the process while releasing the hex lugnut.

The NutCracker is composed of a 20 inch C1018 coldroll bar which is the arm of the operation.

All shear pressures applied during the release of any hex lugnut is directly transferred to this bar. The head of the bar is 2¾ inches long and is welded to one end of the 20 inch C1018 coldroll bar. The head is the receptor for the hex lugnut of the wheel. The sizes will vary depending on the type of vehicle it will be used on. The head is basically a socket that receives the hex lugnut from the wheel. The other end of the 20 inch bar has a eight inch bar welded to it. The 8 inch bar is welded offset at 2½ inches from one edge leaving the other end extending 5½ inches. Four, Two inch steel washers are welded to the 8 inch bar and they work as retainers for the two roller type bearing wheels made of UHMW material. Both wheels are inserted onto the 8 inch bar at there extremities and the washers are spot welded one on each side of the wheel allowing a ⅛ inchfreeplay between the wheels and the washers. The wheels are free floating and have no internal bearings the reason being that the UHMW plastic is a full length stem with 1⅞ inch pieces cut to be used as wheels and the plastic is punctured with a 41/64 hole which will permit the wheel to slip onto the 8 inch shaft at each edge.

The 2½ inch end of the wheel support side also has a socket which permits the user to use the NutCracker also as a powerbar thereby avoiding the use of the shorter lug removing bar found in the trunk of the vehicle thereby avoiding back injuries and permitting the female gender the option of replacing her own tire at will in case of deflation or flat.

### BRIEF DESCRIPTION OF THE DRAWING

In the drawing:

FIG. NC1 page drawing is a plan view of the head and “T” bar assembly of the present invention.

FIG. NC2 page drawing is a plan view of wheel assembly.

FIG. NC3 bottom of page drawing is a plan view of the present invention but with The wheel retaining washers and ⅜″ box adaptor for the socket.

### BRIEF DESCRIPTION OF THE PHOTOS

(please refer to previously submitted in provisional application #60/351,737)

PHOTO 1. Rear left wheel application for releasing nuts.

PHOTO 2. Forward left wheel application for releasing nuts.

PHOTO 3. Forward right hand application for releasing nuts.

PHOTO 4. Rear right hand application for releasing nuts.

### DETAILED DESCRIPTION OF THE PREFERRED EMBODIMENTS

Referring to the drawing, in particular FIG. NC1. Top of page. The tool comprises a steel bar which is preferably made of C1018 ColdRoll steel. At the head of the tool means 1, FIG. NC1 is the adaptor assembly that receives the socket for releasing purposes of the lugnut. The the adaptor ⅜″ box is welded at a 90 degree angle to facilitate insertion of the tool and it's use.

At the other end means 2 is the “T” bar FIG. NC1 page, which supports the means 4 two plastic wheels made preferably from FIG. NC2 page, of UHMW plastic. Note that the “T” bar means 2 is welded offset to the means 3 main 20 inch bar 2½ inches from outboard edge and the inboard part of the bar sets in at 5½ inches FIG. NC1. This offset is to compensate for the torque that will be applied on the inboard wheel of the NutCracker when the motor vehicle is in movement.

The outboard side of the “T” bar on the short side FIG. NC3 page, also comprises mean 6 a socket which permits the individual to use the NutCracker as a powerbar went wanting to release the nut physically. To retain the wheels in place the “T” bar has four means 5 steel washers welded to the bar FIG. NC3.

While specific embodiments of the invention have been shown and described in detail to illustrate the application of the principles of the invention, it will be understood that the invention may be embodied otherwise without departing from such principles.

[image]

What is claimed is:

1. A portable motor vehicule wheel lugnut said releaser comprising

2. A twenty inch bar with a said welded adaptor with box (½″) at one end offset to 90 degree's to receive socket for releasing lugnut.

3. A second said 8 inch bar welded at the other end to form a “T” shape to support said two floating wheels at each extremity held into place by washers on each side of the wheels. The washers being said spot welded in place.

4. (A portable motor vehicule wheel lugnut releaser in accordance with claim 1, wherein:
said first adapted to a multiple lugnut releasing apparatus capable of releasing 4 or more lugnuts simultaneously.)

5. (A portable motor vehicule wheel lugnut releaser in accordance with claim 1, further comprising:
said first adapted to be incorporated to the vehicle/vehicles chassis or framework as a fixed unit thereby utilizing the vehicule/vehicules chassis or frame as the torque receiving end when releasing lugnut/lugnuts.)

6. (A portable motor vehicule wheel lugnut releaser in accordance with claim 1, wherein:
Said first power bar is adaptable to vehicule chassis or frame to release lugnut/lugnuts.)

7. (A portable motor vehicle wheel lugnut releaser in accordance with claim 1, wherein:
Said first two guide stems are utilized to facilitate wheel installation after it's removal with the Nutcracker tool.)
